(19) United States
(12) Patent Application Publication
(10) Pub. No.: US 2012/0138614 A1
(43) Pub. Date: Jun. 7, 2012

(54) WASTE BINS

(76) Inventors: Tim Libby-Mills, St Sozy (FR); Ben Libby-Mills, Bristol (GB)

(21) Appl. No.: 13/261,177

(22) PCT Filed: Aug. 13, 2010
(86) PCT No.: PCT/GB2010/051341

§ 371 Date: Feb. 10, 2012

(30) Foreign Application Priority Data
Aug. 13, 2009 (GB) 0914153.2

(51) Int. Cl. B65F 1/14; B65D 88/74

(52) U.S. Cl. 220/501

(57) ABSTRACT

A wheelie bin having a base (30) and four side walls (31) defining an internal storage space (32) with a top opening (33) containing a freshener which includes an elongate hollow casing (1) which is secured in an upright position containing an absorbent wick (3). The freshener has a filler aperture (19) at the top end provided with a filler cap (4) through which a liquid freshening medium can be poured into the casing, e.g. one or more of a disinfectant, an insecticide, an insect repellent, a deodorant and a fragrance. The casing (1) is provided with vent holes (10) through which vaporised freshening medium may pass into the contents of the internal storage space (32), and vent guards (11) are provided at intervals to prevent the vent holes (10) becoming blocked.

### TECHNICAL FIELD OF THE INVENTION

This invention relates to waste bins, and particularly, without prejudice to the generality, the kind of wheeled rectangular waste bins which are frequently referred to as “wheelie bins”.

### BACKGROUND

Wheelie bins come in a range of sizes, typically 60 Itr, 80 Itr, 120 Itr and 240 Itr household bins or 360 Itr, 660 Itr, and 1,100 Itr commercial bins. Such waste bins have become a part of every day life, and are found worldwide in various shapes and sizes. Increasing public awareness of ‘green issues’, and the need to recycle waste in a responsible manner, have become major issues, not only to the public at large but also for local authorities who are responsible for purchasing the bins and for promoting and encouraging recycling initiatives. Although local authorities generally encourage recycling, collection points often do not provide the user with a pleasant experience.

Both communal (commercial) and household disposal points suffer from many problems. Strong odours of rotting organic waste are usually evident some distance from the waste bins, and they are considerably worse when the lid is opened to deposit waste material into the bin. The number of weekly collections of refuse varies from area to area, and from season to season. Many authorities now only undertake fortnightly collections, regardless of whether it is winter or summer. The problem of bad smells is exacerbated in the warmer months. This applies to both the larger commercial bins and the smaller household bins. Overloading, mis-usage, and dirty bins encourages scavenging animals and insects and creates a perfect breeding habitat for egg laying flies, namely blow flies. This in turn raises the question of possible health hazards. Fly maggots appear approximately 23 hours after the eggs are laid. These bins also attract less unpleasant but undesirable insects such as ants and wasps.

A rise in spring and summer temperatures, not only increases the decomposition time of organic waste but also creates the perfect breeding environment for flying and non-flying insects. These insects enter the bins interior not only from damaged and warped lids but in the case of the larger commercial wheelie bins, from their open circular drainage holes. A temperature test has shown that when the outside temperature (shade temperature) was 25 degrees centigrade the interior temperature rose to 41 degrees centigrade.

In many countries separate bins are provided for different usage (usually colour coded), with large graphic signs which clearly inform the user about acceptable bin content and usage. However, observations have shown that such bins often contain:
a) A mix of both organic and recyclable waste in the same bin, including glass bottles etc.
b) Organic waste disposed of in partially open tied plastic refuse sacks, allowing flies and insects to enter.
c) Organic household waste, namely vegetable waste, and animal waste emptied loose into the container.
d) Drink containers, yoghurt pots etc. with sugar residues exposed.

Both the large, and smaller wheelie bins continue to produce many justified complaints from the public (the users) to local authorities, concerning the odour present and the number of flies/maggots, whether or not the bins have been internally cleaned.

The present invention seeks to provide a new and inventive way of reducing the unpleasantness of waste bins which is effective and reliable in operation.

### SUMMARY OF THE INVENTION

The present invention proposes a waste bin having a base and four side walls defining an internal storage space with a top opening, in which the internal storage space contains a freshener which includes a hollow casing with a filler aperture at the top end, accessible through the top opening, for placing a freshening medium in the casing, and the casing is provided with an array of holes through which the freshening medium may pass from the casing into the contents of the storage space,
characterised in that the elongate hollow casing is disposed in an upright position occupying at least 50% of the height of the storage space.

The casing preferably occupies between 50% and 70% of the height of the storage space. This ensures that at least part of the freshener is below any substantial quantity of waste material in the bin. If a freshening medium of a volatile nature is used the medium will be subject to increased evaporation in the presence of waste material, producing self-activation of the freshening medium.

In order to ensure that the freshening medium is distributed throughout the depth of the bin the freshening medium is preferably incorporated in an absorbent carrier, which may be pre-shaped to be a close sliding fit in the casing. The freshening medium may include one or more of a disinfectant, an insecticide, an insect repellent, a deodorant and a fragrance.

There is preferably a non-perforated region at the bottom end of the casing to act as a reservoir for liquid freshening medium. It is also an advantage to have a similar non-perforated region at the top end of the casing to hold liquid freshening medium which is poured into the casing.

The casing is preferably provided with projecting vent guards, such as transversely extending bars, which are spaced apart at intervals along the casing to prevent the vent holes being blocked by the contents of the bin.

In order to occupy minimum space with a low risk of rubbish becoming lodged around the freshener, the casing may comprises a curved rear wall and a non-curved front wall in which the vent holes are provided. The rear wall preferably has a curved mid region flanked by mutually perpendicular substantially flat regions.

### BRIEF DESCRIPTION OF THE DRAWINGS

The following description and the accompanying drawings referred to therein are included by way of non-limiting example in order to illustrate how the invention may be put into practice.

In the drawings:

FIG. 1 is an exploded general view of a bin freshener in accordance with the invention;

FIG. 2 is a transverse cross-section through the casing of the bin freshener;

FIG. 3 is a general view of the assembled bin freshener shown in its normal use position;

FIG. 4 is a front view of a domestic wheelie bin in which the bin freshener is installed and shown in ghost outline; and

FIG. 5 is a ghost side view of the same wheelie bin.

### DETAILED DESCRIPTION OF THE DRAWINGS

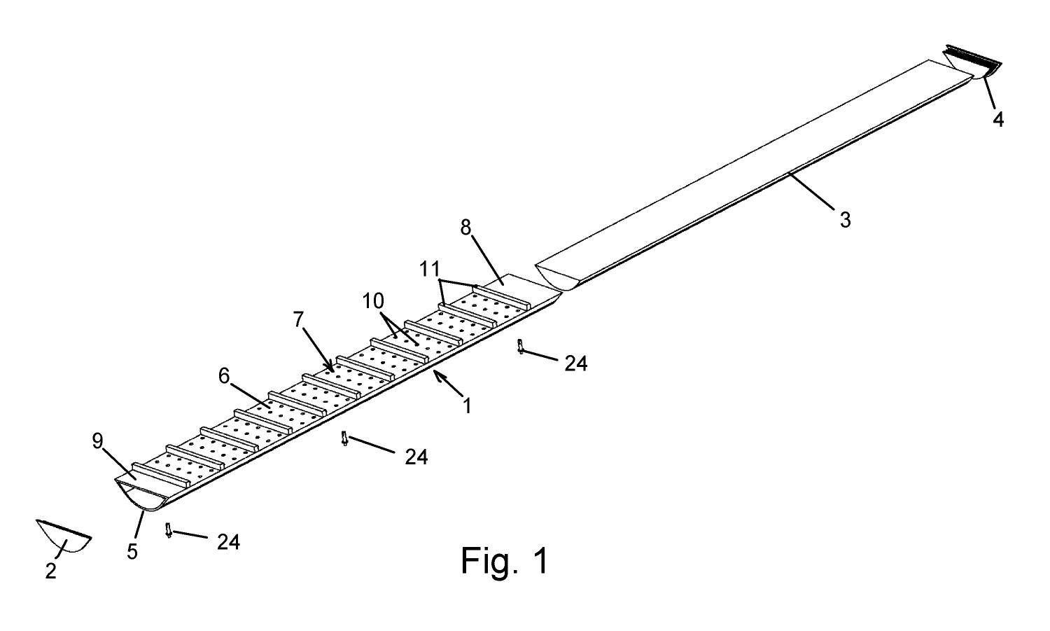

Referring firstly to FIG. 1, the main components of the bin freshener include an elongate hollow casing 1 with a base cap 2, an absorbent wick 3, and a removable filler cap 4. The casing 1 has a curved rear wall 5 and a planar front wall 6, and is normally closed at the bottom end by the base cap 2 which may be snapped, glued, welded or otherwise sealingly secured in place. The front wall 6 incorporates a perforated vent region 7 which occupies most of its length between non-perforated top and bottom regions 8 and 9. The perforated region contains numerous vent holes 10, and is also provided with projecting vent guards 11 which are spaced apart at longitudinal intervals, which may conveniently take the form of transversely extending bars.

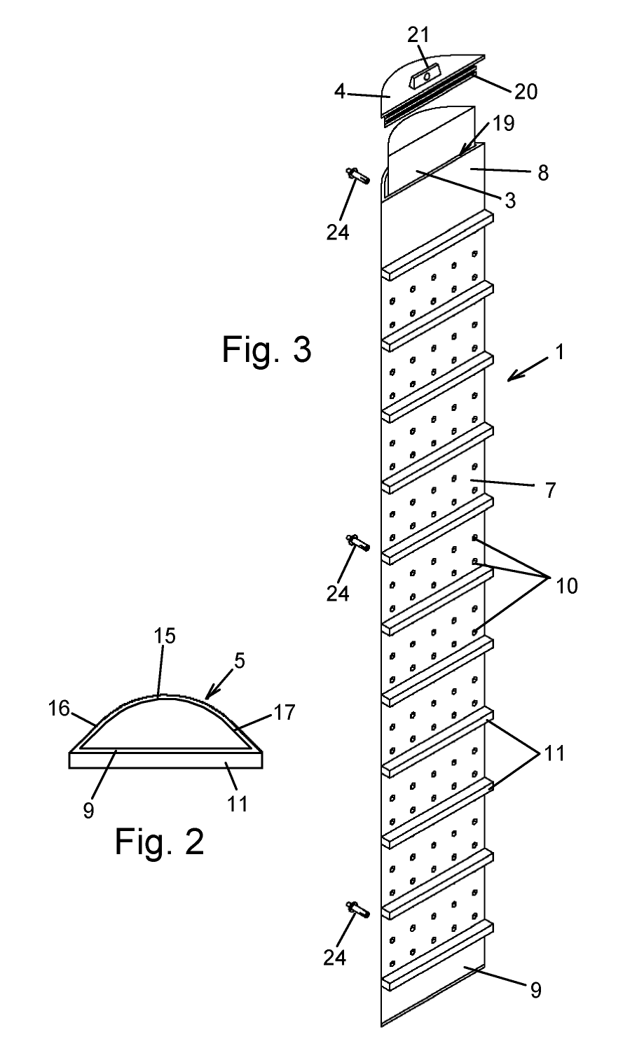

As shown in the enlarged cross-sectional detail of FIG. 2, the rear wall 5 is symmetrical with a quarter-circle central region 15 disposed between mutually perpendicular outer regions 16 and 17.

The filler cap 4 is best seen in FIG. 3, and is shaped to be an interference fit in a filler aperture 19 formed by the open upper end of the casing 1, e.g. by means of a short ridged wall 20. The cap may also be provided with a handle 21, which in this example is apertured for attachment of a cord, wire or chain to prevent the cap being lost in use.

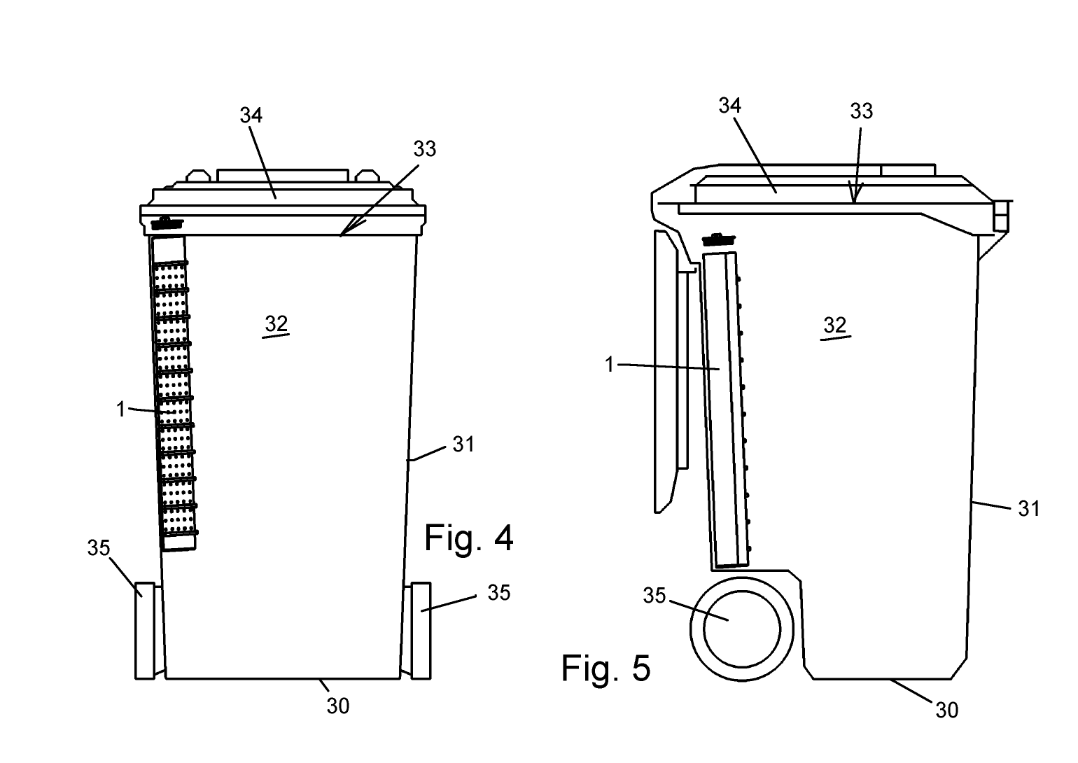

In use, the bin freshener can be fixed inside a wheelie bin as shown in FIGS. 4 and 5. Although the drawings show a typical domestic wheelie bin the freshener can be installed in any similar waste bin in the same way. The wheelie bin is of well known configuration having a base 30 and four side walls 31 defining an internal space 32 with a top opening 33 provided with a hinged lid 34. The bottom of the bin is recessed at the rear to receive a pair of wheels 35, which can conveniently be used to move the bin when tilted rearwards onto the wheels. The casing is shaped to fit snugly in one of the four internal corners of the bin with the flat sections 16 and 17 of rear wall 5 against two adjacent sides of the bin. The freshener can be held in place by any semi-permanent means such as an adhesive, self-tapping screws or, as in this example, rivets 24 shown in FIGS. 1 and 3. In general it is preferable to enable the bin freshener to be removed and re-fitted to another bin if desired, although it might also be possible to mould the casing integrally with the wheelie bin in some cases. The freshener is mounted in an upright position with the filler aperture 19 at the top end of the casing, accessible through the top opening 33 of the wheelie bin. The filler opening is therefore at or above the normal level of rubbish placed in the bin. The casing 1 occupies about 66% of the height of the internal space 32 so that at least part of the absorbent wick 3 is normally below the level of any substantial quantity of waste material. Waste materials tend to store heat, and often generate heat by biological activity, so that volatile substances in the wick are subject to increased evaporation even if the bin is only partially full.

The absorbent wick 3 may comprise a length of sponge plastic material which is pre-shaped to be a close sliding fit inside the casing 1. The wick is used to hold a liquid freshening medium which may include one or more of a disinfectant, an insecticide, an insect repellent, a deodorant and a fragrance. The freshening medium can be poured into the casing to be taken up by the wick, or a fresh wick charged with the medium can be inserted into the container after any spent wick has been removed. As an alternative to a wick element the casing could be filled with an absorbent granular material containing one or more of the substances listed above.

The non-perforated top region 8 prevents liquid from spilling out of the casing when it is poured onto the wick. It is preferable for the wick to terminate above the vent holes leaving a space between the wick and the cap 4. This allows liquid to be poured into the top of the casing without spilling out of the vent holes and allows the liquid to percolate down into the wick at its own rate. The non-perforated bottom region 9 may act as a second liquid reservoir which holds excess liquid medium to be drawn up by the wick. As the substance evaporates from the wick it passes through the vent holes 10 and percolates into the rubbish deposited in the bin, resulting in sanitizing or deodorising of the contents and killing any insects which enter the rubbish, depending on the nature of the freshening medium which is used. The projecting vent guards 11 act to hold rubbish off the front wall 6 to prevent the vent holes from becoming blocked by the bin contents.

Larger commercial wheelie bins are often provided with one or more drainage holes at the bottom, and this allows air to be drawn through the rubbish whenever the lid is opened, thereby assisting in drawing the freshening substance through the contents of the bin.

The bin freshener is very effective and reliable. It works entirely on evaporation assisted by any temperature rise within the bin, and does not require batteries or a mechanical pump.

The wick can be provided with a pull cord to assist withdrawal of the wick from the casing. The casing can then be cleaned if necessary and a fresh wick inserted.

The bin freshener can be manufactured in different sizes to fit different size bins. A freshener for the larger wheelie bins (660 Itrs to 1,100 Itrs) could include a plastic partition running longitudinally along the length of the casing spanning the front and rear walls. This would allow the casing to contain two separate wicks, one filled with a disinfectant, the other with an insect repellent or insecticide.

The bottom end of the casing need not be flat as shown in the drawings, but could instead be inclined in an upward direction from back to front. This reduces the risk that items will become lodged beneath the bin freshener when the bin is emptied.

Larger commercial size bins normally have four wheels, one at each corner, and they are not normally provided with a moulded recess to receive the wheels. They do however have a sunken recess that runs across the base containing one or more drainage holes.

It should be noted that although the device is extremely effective at freshening bins it only takes up a minimal amount of space within the bin, typically about 1 Itr for a domestic bin and about 2 Itrs for larger commercial bins.

Whilst the above description places emphasis on the areas which are believed to be new and addresses specific problems which have been identified, it is intended that the features disclosed herein may be used in any combination which is capable of providing a new and useful advance in the art.

1. A waste bin having a base (30) and four side walls (31) defining an internal storage space (32) with a top opening (33), in which the internal storage space contains a freshener which includes a hollow casing (1) with a filler aperture (19) at the top end, accessible through the top opening (33), for placing a freshening medium in the casing, and the casing is provided with an array of holes (10) through which the freshening medium may pass from the casing into the contents of the storage space (32),
characterised in that the hollow casing (1) is disposed in an upright position occupying at least 50% of the height of the storage space (32).

2. A waste bin according to claim 1 in which the freshening medium is incorporated in an absorbent carrier (3).

3. A waste bin according to claim 2 in which the absorbent carrier (3) is pre-shaped to be a close sliding fit in the casing.

4. A waste bin according to claim 1 in which the freshening medium includes one or more of a disinfectant, an insecticide, an insect repellent, a deodorant and a fragrance.

5. A waste bin according to claim 1 in which there is a non-perforated region (9) at the bottom end of the casing to act as a reservoir for liquid freshening medium.

6. A waste bin according to claim 1 in which there is a non-perforated region (8) at the top end of the casing to hold liquid freshening medium poured into the casing.

7. A waste bin according to claim 1 in which the filler aperture (19) is provided with a removable filler cap (4).

8. A waste bin according to claim 1 in which the casing is provided with projecting vent guards (11) which are spaced apart at intervals along the casing.

9. A waste bin according to claim 8 in which the vent guards (11) comprise transversely extending bars.

10. A waste bin according to claim 1 in which the casing comprises a curved rear wall (5) and a non-curved front wall (6).

11. A waste bin according to claim 10 in which the rear wall (5) comprises a curved mid region (15) flanked by mutually perpendicular substantially flat regions (16, 17).

12. A waste bin according to claim 10 in which the vent holes (10) are provided in the front wall (6).

13. A waste bin according to claim 1 in which the elongate hollow casing (1) occupies less than 70% of the height of the storage space (32).
